(19) United States
(12) Patent Application Publication
(10) Pub. No.: US 2005/0019724 A1
(43) Pub. Date: Jan. 27, 2005

(54) Tooth powdering applicator with nozzle spray control

(76) Inventor: David E. Lawler, Bloomington, IN (US)

Correspondence Address: Woodard, Emhardt, Moriarty, McNett & Henry LLP;Bank One Center/Tower, Suite 3700, 111 Monument Circle, Indianapolis, IN, 46204-5137, US

(21) Appl. No.: 10/704,927

(22) Filed: Nov. 10, 2003

Related U.S. Application Data
(60) Provisional application No. 60/490,360, filed on Jul. 25, 2003.

(51) Int. Cl. A61C 17/02; A61C 3/02

(52) U.S. Cl. 433/80; 433/88

(57) ABSTRACT

A tooth powdering applicator. A container for holding infrared reflective powder has an inlet connected to a source of pressurized gas and an outlet tube that is both rotatable and slidable along its longitudinal axis to direct and control flow of powder spray. An air filter is connected between a source of pressurized gas and the outlet tube.

### REFERENCE TO RELATED APPLICATION

This application claims the benefit of U.S. Provisional Patent Application 60/490,360, filed Jul. 25, 2003 and entitled “Tooth Powdering Applicator with In-Line Air Filter.”

### BACKGROUND OF THE INVENTION

The present invention relates generally to the field of dental tools.

### DESCRIPTION OF THE PRIOR ART

The traditional method of creating a replica tooth is to apply a pliable molding material around the tooth to be replaced with a replica then being created by the cavity formed in the molding material. More recent dental restoration technology utilizes an infrared camera. A white reflective powder comprised of titanium dioxide and talc is applied to the whole tooth creating a uniform color on the tooth and providing a means whereby the infrared camera can photograph and digitize the old tooth. Prior to the powder being sprayed onto the tooth, the dentist prepares the tooth for the porcelain restoration by removing the silver fillings and any lingering decay. A hand held infrared camera is then used to provide an image of the tooth onto a video screen. The replica tooth is then designed through the use of a computer. Once the design of the replica tooth is completed, the dentist utilizes a milling machine for cutting the actual replica tooth from a ceramic block. Such a system is manufactured by Siemens Dental Products Division and distributed in the U.S. by the Patterson Dental Supply Company under the name CEREC.

The current technique of applying the reflective powder involves two containers connected together. One container is an aerosol of pressurized butane gas having an outlet directed through a second container of reflective powder which, in turn, has a flexible tube extending therefrom through which the powder is sprayed. Such an applicator is distributed by Vita Zahnfabrik H. Rauter Graph and Co., KG of Bad Sackingen, Germany.

Difficulties are encountered when applying the powder in remote locations of the mouth. The powder needs to be applied evenly. If the powder is too thick on one portion of the tooth then an inaccurate reading by the camera results since the camera reads the top surface of the powder. In many cases, the patient's cheek is in the proximity of the side of the tooth and thus must be forced outwardly therefrom in order for the powder to be sprayed evenly on the side of the tooth. The prior applicator includes an outlet stem which will bend when contacted against the cheek.

In my U.S. Pat. Nos. 5,944,521 and 6,099,306, I have provided a rigid outlet tube to simultaneously force the cheek away from the tooth while powder is being sprayed by the tube onto the tooth. Thus, the dentist may with a single hand move the cheek away from the tooth while spraying the powder. Further, since the tooth has both vertical and horizontal surfaces and surfaces therebetween, the powder must be sprayed at various angles. As a result, the prior art powder applicator requires the dentist to tilt the container of powder in order to properly point the powder outlet towards the tooth surface. Once the powder container is tilted then it is possible for the powder to clump within the container and even clog the outlet. The applicator disclosed in my aforementioned U.S. patents, has a powder outlet tube rotatable about its longitudinal axis while allowing the powder container to remain in an upright position. The dentist's hand holding the powder applicator may also be used to rotate the powder outlet tube without necessitating use of the remaining hand of the dentist. The one hand adjustment of the nozzle makes application of powder more precise and more predictable. The powder spray can be directed with complete precision at no risk of clumping or uneven flow.

My patented applicator has a powder outlet tube with a right angle bend on the distal end outlet allowing for more easy application of powder in remote areas of the mouth as compared to the prior device having a distal end extending at an angle from the longitudinal axis less than 90°. In an alternate embodiment, a valve on the powder container allows the dentist to control the flow with the same hand holding the container allowing for accurate powder application.

A further problem with some of the prior art applicators, is the attachment of an air filter to the handle of the applicator to remove moisture from the pressurized air. The applicator therefore becomes bulky and quite difficult to use. Disclosed herein is an in-line air filter located apart from the hand held tool allowing the tool to be moved quickly and with ease.

Additional problems of some of the prior applicators is the location of the on/off valve for controlling the air pressure to the applicator with the valve being located remotely from the hand holding the applicator. Thus, the dentist must use both hands to operate the applicator. Disclosed herein is an applicator that includes the advantages of my prior applicators but also locates a control on the applicator outlet tube enabling the dentist to use a single hand for both pointing the outlet nozzle towards the tooth and controlling the flow of powder spray.

### SUMMARY OF THE INVENTION

One embodiment of the present invention is a tooth powdering applicator comprising a container for holding reflective powder to be applied to a tooth to form a reflective coating thereon. The container has a fluid inlet and a powder outlet with a cover movably mounted to the container to allow insertion of powder into the container. A hose is connected to the dental air supply and to the container inlet. An outlet tube has an end connected to the powder outlet to receive powder from the container as forced therefrom by gas introduced into the container from the hose. The outlet tube is rotatably mounted and slidably mounted to the container thereby enabling the dentist in a one hand handed fashion to point the nozzle towards the tooth to be sprayed while controlling the powder emitted from the outlet tube. An air filter is attached to the dental air supply and in turn to the inlet hose attached to the powder outlet.

It is an object of the present invention to provide a new and improved tool for applying reflective powder to a tooth.

A further object of the present invention is to provide a new and improved dental tool.

A further object of the present invention is to provide an improved air filter located remotely from a tool for applying reflective powder to a tooth that filters the pressurized air for the tool.

Yet a further object of the present invention is to provide a dental tool for use with a single hand in directing the powder sprayed onto the tooth while controlling the flow of power emitted from the tool.

Related objects and advantages of the present invention will be apparent from the following description.

### BRIEF DESCRIPTION OF THE DRAWINGS

FIG. 1 is a view of an alternate embodiment of the powder applicator incorporating my new invention.

FIG. 2 is an enlarged fragmentary cross-sectional view of the applicator of FIG. 1.

FIG. 3 is an enlarged side view of an air filter connected in line with the inlet tube of the tooth powdering applicator shown in FIG. 1.

FIG. 4 is a view of the preferred embodiment of the powder applicator incorporating my new invention.

FIG. 5 is an enlarged fragmentary cross-sectional view of the powder applicator shown in FIG. 4.

FIG. 6 is an enlarged view of the air filter and air regulator connected between the source of pressurized air and the powder container as shown in FIG. 4.

### DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

Referring now more particularly to the drawings, there is shown an alternate embodiment of a tooth powdering applicator 10 including a container 11 for holding the reflective powder to be applied to the tooth to form a reflective coating thereon. The container has a fluid inlet 12 and a powder outlet 13 provided in the removable container cover 14. A flexible fluid hose 15 has one end connected to inlet 12 and opposite end 42 connected via filter 35 to a source 16 of pressurized fluid. A rigid metal tube 17 has a proximal end connected to outlet 13 and a distal end 18 through which the powder is sprayed on the tooth. The outlet end 18 is arranged at a 90° angle relative to the longitudinal axis 19 of the tube.

Container 11 is hollow for holding a titanium oxide and talc powder. The top end 20 has a reduced diameter and is externally threaded to meshingly engage with the internally threaded bottom end 21 of cover 14. Thus, cover 14 may be unthreaded from the container to allow for insertion of new powder.

A rigid tube 22 is connected to inlet 12 and has a bottom end 23 extending downwardly into the container. An optional push button valve 24 is mounted to the top of cover 14 and has a member 25 extending downwardly into tube 22. The push button valve and member 25 are spring biased to normally position the member 25 to block flow through tube 22. When the push button is depressed, member 25 moves downwardly aligning passage 35 with tube 22 allowing flow of fluid through the tube. Passage 35 extends through member 25. Other alternative valve structures may be provided in order to control the flow of fluid into the container or the flow of fluid and powder out of the container.

Outlet 13 is connected to an internal passage 26 that opens into the container above an optional mesh screen 27 positioned between the top end 20 of the container and cover 14. The screen extends between the internal threads of the cover thereby filtering the flow of powder out through passage 26 and preventing the powder from clogging passage 26. Source 16 is the dental air supply and is operable to force pressurized fluid, such as air or inert gas, into the container exiting bottom end 23 of tube 22 thereby stirring the powder within the container and forcing the powder upwardly through screen 27 and out passage 26 to tube 17.

Tube 17 is movably or rotatably mounted to outlet 13 of the applicator. In the embodiment shown in the drawings, outlet 13 includes an externally threaded male connector 28 that threadedly receives an internally threaded female connector 29. Tube 17 has a conically shaped end 30 received in a complimentary sized outlet provided in male connector 28. Tube 17 is rotatable about its longitudinal axis relative to female connector 29. A resilient O-ring 31 extends around male connector 28. Thus, female connector 29 is threadedly mounted onto male connector 28 thereby compressing O-ring 31. Tube 17 is fully rotatably about its longitudinal axis relative to male connector 28 even though connectors 28 and 29 remain stationary. Thus, distal end 18 may be pointed at different angles towards the tooth even though container 11 remains in an upright position.

Disk 32 is fixedly mounted and extends around tube 17 and is rotatably therewith. The circumferential surface of disk 32 provides a finger contact surface allowing the dentist to grasp container 11 with one hand insuring the container remains in an upright position while extending a finger from the same hand onto disk 32 to rotate distal end 18 toward the tooth to be coated. Simultaneously, a finger of the same hand may be used to operate push button valve 24.

Many advantages of the present invention exist over the prior devices. The ability to swivel end 18 while ensuring container 11 is in a stationary or upright position reduces the risk of uneven powder spray. Likewise, screen 27 further limits the uneven powder flow and prevents powder clumping particularly at the inlet of passage 26. The rigid tube 17 may be used to push aside the patient's cheek while the powder is emitted therefrom.

An optional fluid control device 33 may be mounted to hose 15 to control the flow of pressurized fluid through the hose. Hose 15 merely extends through control 33 which has a rotatable stem 34 contactable against the outside surface of the hose to squeeze the hose and restrict the internal diameter thereof. Thus, control 33 may be used as a rough or general control of the pressurized fluid through the hose whereas valve 24 may be used to more finely control the flow of fluid. The tubular shape of container 11 allows the container to be grasped with a single hand with the thumb then being used to depress valve 24 while a finger contacts disk 32 to properly position nozzle outlet 18.

The container includes a circuitous passage consisting of tube 22 extending horizontally from inlet 12 and then vertically downward with the fluid then exiting into the container and flowing back upwardly with the powder entering passage 26. The circuitous passage causes turbulence within the container to stir the powder contained therein.

The removable outlet tube 17 is produced from metal and therefore can be placed in a sterilizer for subsequent use as compared to the prior devices having a plastic outlet tube which must be discarded after a single use.

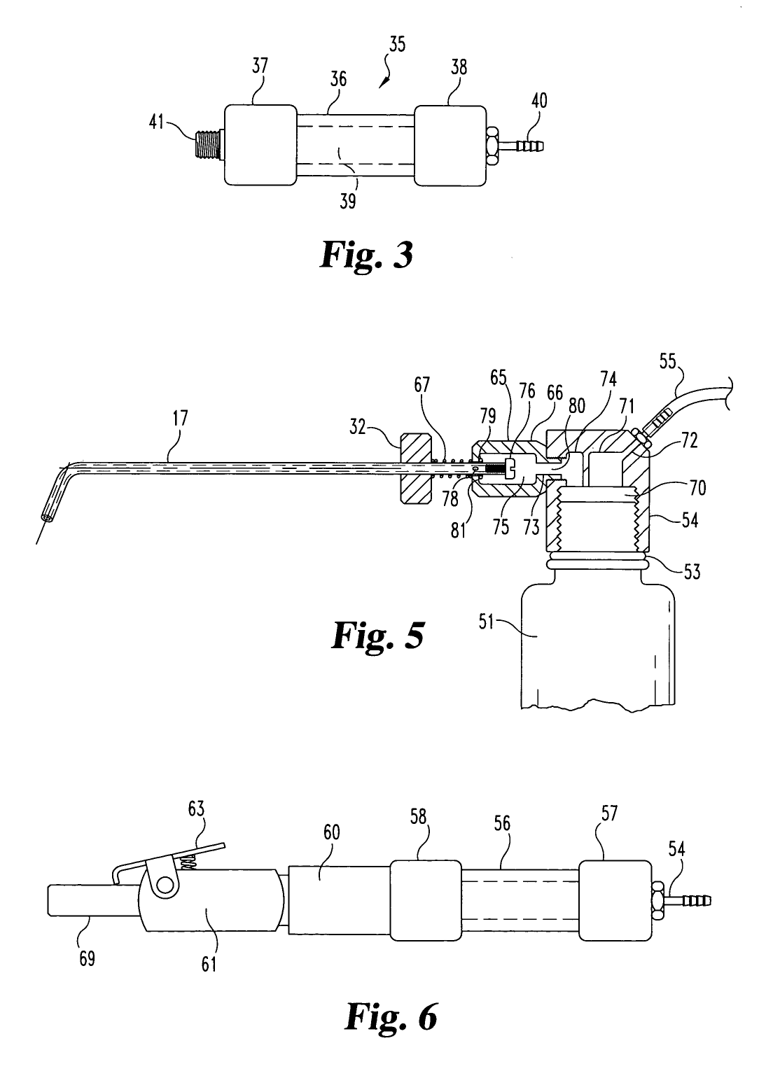

Air filter 35 is connected in line between the end 42 of hose 15 and the source 16 of pressurized air. Filter 35(Fig. 3) has a hollow tubular main body 36 capped at opposite ends by caps 37 and 38. A suitable filter media 39, such as, a cotton roll is positioned within main body 36 between caps 37 and 38 to remove moisture from the pressurized air flowing through the filter. An externally threaded inlet fitting 41 is connected by a conventional connector to source 16 of pressurized air whereas a barbed fitting 40 extends into end 42 of hose 15. Fittings 40 and 41 are hollow allowing the pressurized air to flow from source 16 through main body 36 to hose 15.

Caps 37 and 38 may be fixedly mounted to main body in which case filter 35 is a throwaway item. Alternatively, the caps may be removed from main body 36 to allow for replacement of media 39. In the case of removable caps, the caps may be threaded onto main body 35 or held thereon by other conventional means.

Many variations are contemplated and included in the present invention. For example, the push button valve 24 is optional and may be used where the source of pressurized fluid has either an on or off position without any variable control provided on the source. The push valve allows the dentist to control the flow of fluid in such instances. On the other hand, the push button valve may not be required if the source of pressurized fluid is provided with a control, such as, a foot valve allowing for variable flow. In one embodiment, the air control valve 24 may be built into the stem 17 that is slidably movable to and from container 11 to control the flow of pressurized air and powder.

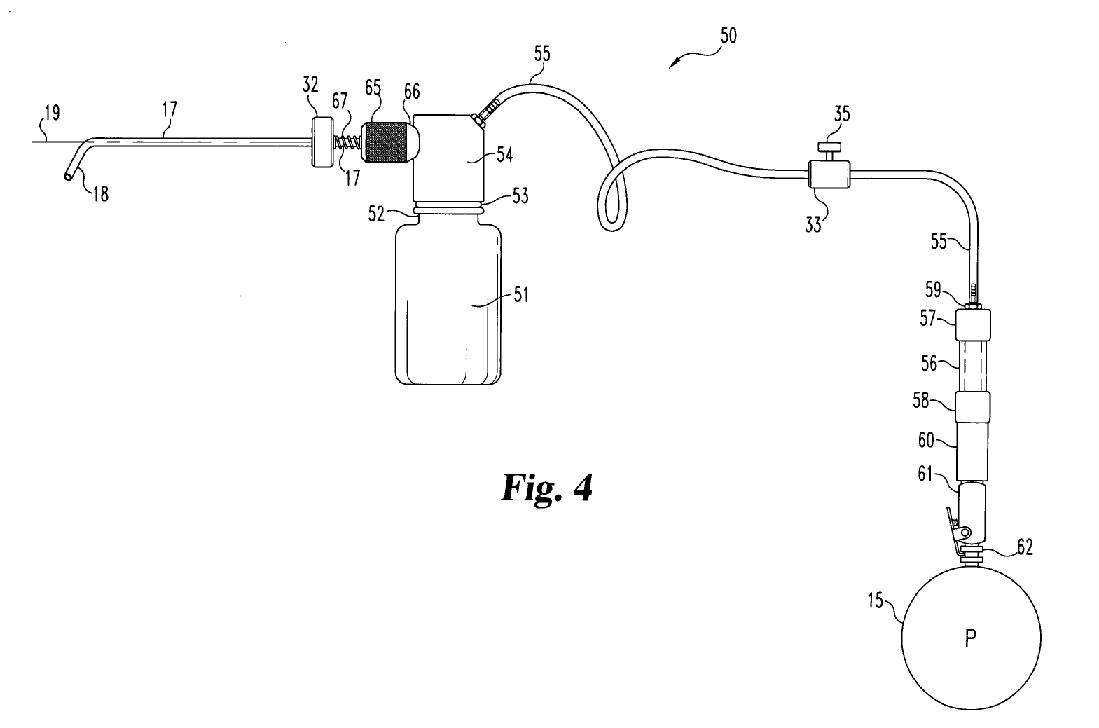

The preferred embodiment of the tooth powdering applicator 50 is shown in FIG. 4 and includes a container 51 for holding the reflective powder to be applied to the tooth to form the reflective coating on the tooth. The container has a fluid inlet 72 and fluid outlet 80 (FIG. 5) formed in the cap 54 of the container. The top end 52 (FIG. 4) of the container is externally threaded to receive the internal threads of cap 54 allowing the cap to be removed for the insertion of additional powder. An O-ring seal 53 is located between the bottom end of the cap and an enlarged flange of the top end of the container to effect a seal between the two.

A flexible hose 55 has one end sealingly connected to cap inlet 72 and an opposite end connected to the outlet 59 of an air filter similar to the filter 35 previously described and shown in FIG. 3. The optional fluid control device 33 previously described for the alternate embodiment may be mounted to hose 55 and includes a thumb screw 35 for controlling the flow of pressurized gas or air through the hose.

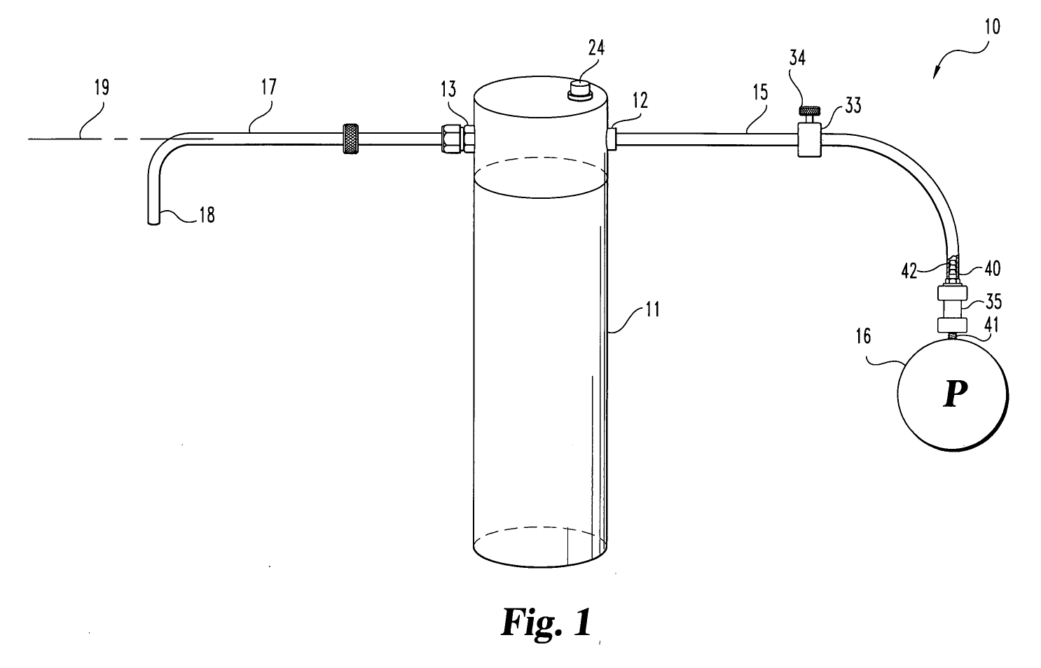

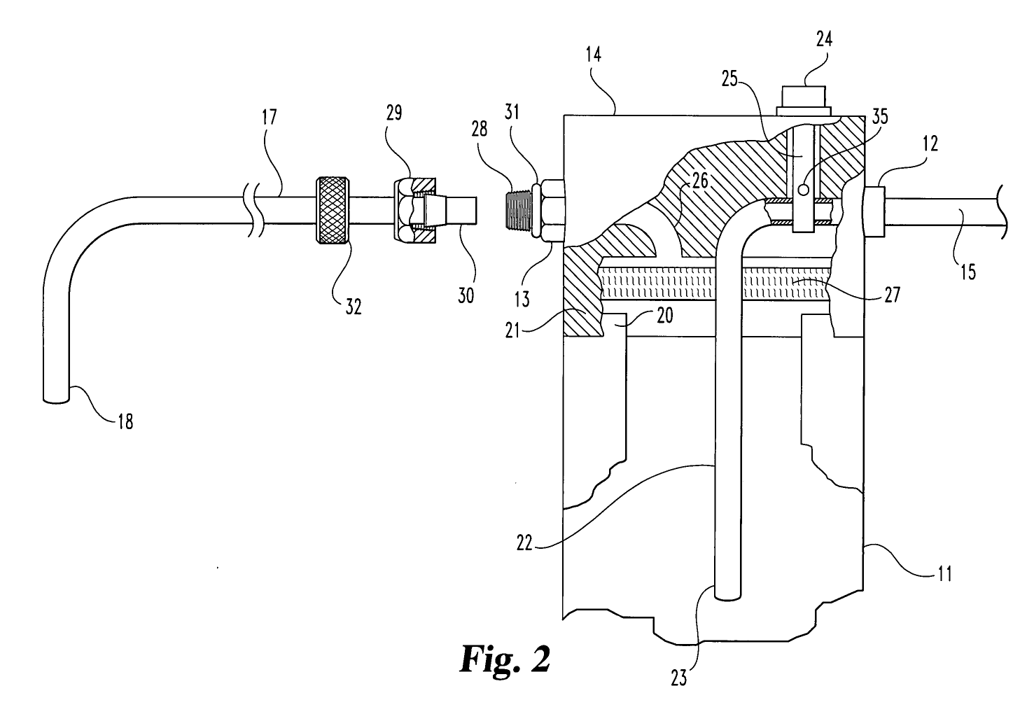

A rigid tube 17 is slidably and rotatably mounted to the outlet of the container cap. The tube has longitudinal axis 19 about which the tube may rotate or pivot with the distal end 18 of the tube extending downwardly from axis 19 at an angle. The angle between distal end 18 and axis 19 may either be 90 degrees as illustrated for the alternate embodiment of FIG. 1 or may be at an acute angle as illustrated in FIG. 4. The finger control disc 32 previously described is fixedly mounted to tube 17 to enable the dentist to rotate the tube and point the distal end at the tooth directing powder thereon.

Cap 54 is hollow forming a cavity 70 located above the top end of the container. The cap inlet 72 in fluid communication with hose 55 opens into an inlet cavity 71, in turn, opening into cavity 70. The cap outlet 80 likewise opens into an outlet cavity 74, in turn, opening into cavity 70. A wall separates cavity 74 from cavity 71 and directs the pressurized gas or air entering into cavity 71 down into cavity 70. The pressurized air continues to flow downwardly into the container mixing with the powder and forcing the powder upwardly through cavity 70 and into outlet cavity 74 where the pressurized gas and powder flow through the outlet 80 which forms an outlet port. Outlet 80 is internally threaded and is in meshing engagement with the external threads of the reduced diametered proximal end 73 of extension 65. Tube 17 may be rotated about axis 19 and may be moved toward the container along the axis to the open position with both movements being controlled by the finger of the hand that holds the container in a stationary position.

Outlet extension 65 is hollow and is fixedly mounted to the cap. Extension 65 has a tapered end portion 66 extending to the externally threaded end 73. Tube 17 has a proximal end 79 extending through hole 78 formed in the distal end of extension 65. The tube extends into the chamber 75 formed by extension 65 with the tube being internally threaded to receive the externally threaded shank of a conventional fastener, such as bolt 76. The enlarged head of bolt 76 prevents the head from passing through hole 78 and thereby limits the outward movement of tube 17 relative to extension 65. A conventional O-ring 81 encircles the proximal end 79 of tube 17 and effects an airtight seal between the tube and hole 78. A conventional helical spring 67 encircles tube 17 having one end contacting one side of disc 32 with the opposite end of the spring contacting the outer wall of extension 65. Spring 67 when fully extended causes enlarged head 76 to contact O-ring 80 limiting or preventing further outward movement of tube 17 along axis 19.

Tube 17 is hollow having a passage extending through the tube to distal end 18. The hollow passage of the tube opens outwardly through a side vent 78. When the tube is in the most outward position with the spring fully extended, vent 78 is located outwardly of chamber 75 thereby preventing pressurized gas and powder from escaping the container through tube 17. The dentist may pull disc 32 along axis 19 thereby compressing spring 67 and moving vent 78 into the chamber 75 of extension 65. The spring is therefore yieldable to allow vent 78 to pass O-ring 80 allowing the pressurized gas and powder to flow into the tube and escape the tube via the distal end of the tube providing an open position for the applicator. Container 51 is sized to fit in the dentist hand while the finger of the same hand contacts disc 32 rotating the tube about axis 19 to point the distal end 18 at the tooth to be coated while at the same time sliding the tube along axis 19 to the open position allowing the powder and pressurized gas to escape and be directed onto the tooth.

Gas filter 56 is identical to the air or gas filter 35 previously described with the exception that a gas pressure regulator 60 is mounted to one end of the filter. Thus, filter 56 includes a hollow main body enclosing filter media, such as, a paper, fabric or a metal screen roll with caps 57 and 58 being mounted to the cylindrical main body with at least one of the caps being removable to allow insertion of fresh filter media. The caps may be mounted to the cylindrical main body by being threadedly mounted to the opposite ends. Cap 57 has an outlet end 59 extending mountingly into hose 55 whereas cap 58 is fixedly mounted to a conventional pressure regulator 60 having a sized passage extending therethrough in fluid communication with the filter with the size of the passage limiting or regulating the amount of air flowing through the regulator. The proximal end 61 of the regulator has a spring biased clip 63 pivotally mounted thereon adjacent the inlet tube 69 of the regulator. Tube 69 slidingly extends into the outlet 62 of the source 15 of pressurized gas, such as air, with the distal end of clip 63 being positioned between a pair of spaced apart flanges on outlet 62. The opposite end of the clip may be depressed thereby compressing a spring located between the clip and the main body of the regulator to pivot the distal end of the clip apart from outlet 62 enabling tube 69 to be withdrawn from source 15. Many other variations are contemplated and included in the present invention for securing the air filter to the source of pressurized gas including conventional means.

1-3. (cancelled)

4. A device for coating a tooth with powder to reflect infrared radiation for infrared photography of the tooth comprising:
a container for holding infrared reflective powder;
a flexible hose connected to said container and connectable to a source of pressurized gas; and,
a rigid tube connected to said container and extending outwardly therefrom to hold and spray said powder onto a tooth as forced by pressurized gas from within said container, said tube having a longitudinal axis about which said tube is rotatable and slidable to control flow therefrom allowing the user to rotate and point said tube directing and limiting flow of powder sprayed therefrom while holding said container in one handed fashion.

5. The device of claim 4 and further comprising:
a spring normally urging said tube in a first direction away from said container to a closed position to prevent flow of powder therefrom and yieldable to allow said tube to move an opposite direction from said first direction to an open position to allow flow of powder from said container.

6. The device of claim 5 and further comprising:
a finger engager surface on said tube with said spring positioned between said engager and said container.

7. The device of claim 6 and further comprising:
a gas and powder seal encircling said tube and in sealingly engagement therewith, said tube includes a vent positioned outwardly of said seal when said tube is in said closed position limiting flow of gas and powder into said tube via said vent, said vent positioned inwardly of said seal between said seal and said container when said tube is in said open position allowing flow of gas and powder via said vent into said tube.

8. The device of claim 7 and further comprising:
a gas filter connected to said hose and located remotely relative to said container.

9. The device of claim 8 wherein:
said container includes a cavity and a cap removable from said container to allow insertion of powder into said cavity, said cap includes an gas inlet connected to said hose and an outlet, said outlet includes an extension with a chamber therein, said tube includes a proximal end with an enlarged head positioned within said chamber limiting outwardly movement in said first direction, said seal is located in said chamber.

10. The device of claim 8 and further comprising:
a gas pressure regulator connected to said hose and located remotely relative to said container.

11. A device connectable to a source of pressurized gas for applying powder to a tooth, said device operable by a finger of a hand that is holding the device and comprising:
a container to hold powder to be applied to a tooth, said container having a main body graspable by a hand;
an inlet tube connected to said container and connectable to a source of pressurized gas; and,
a rigid outlet tube with a longitudinal axis mounted to said container and having a closed position and an open position, said outlet tube having a distal end and movably mounted to said container about said axis to point said distal end at the tooth, said outlet tube also mounted to said container to move along said axis in a first direction to said closed position and in a second direction opposite said first direction to said open position, said outlet tube having an interior passage and a tube inlet leading into said passage allowing flow of powder from said container through said outlet tube to said distal end to allow powder within said container to flow outwardly through said outlet tube and onto the tooth when said outlet tube is in said open position and blocking flow of powder through said outlet tube when said outlet tube is in said closed position.

12. The device of claim 11 and further comprising:
a spring urging said outlet tube to said closed position but yieldable to allow said outlet tube to move to said open position.

13. The device of claim 12 and further comprising:
an upraised finger control on said outlet tube to allow a finger to rotate said tube about said axis and to pull said tube along said axis to said open position.

14. A tool for spraying powder with pressurized gas onto a tooth that is designed to be held by one hand and operated by a finger of the hand comprising:
a container having a cavity for holding powder to spray on a tooth, said container having a closeable opening for insertion of powder into said cavity, said container further having an inlet port and an outlet port;
a hose connected to said inlet port for directing pressurized gas into said cavity; and,
a tube slidably mounted to said container and being connected to said outlet port, said tube having a longitudinal axis and being slidable along said axis back an forth between a closed position limiting flow of powder onto a tooth and an open position allowing flow of powder onto a tooth.

15. The tool of claim 14 wherein:
said tube has an outlet end and is movably mounted to said container for movement about said axis allowing said outlet end to be pointed at a tooth while said container remains stationary.

16. The tool of claim 15 wherein:
said container and tube are sized to allow said container to be held in one hand while a finger of the hand rotates said tube about said axis to point said outlet end at a tooth and slides said tube along said axis to said open position allowing powder to be sprayed onto the tooth.

17. The tool of claim 16 wherein:
said outlet port includes an extension with a chamber therein, said tube includes a proximal end with an enlarged head positioned within said chamber limiting outwardly movement of said tube, said tube and extension includes a seal positioned within said chamber limiting flow of pressurized gas and powder into said tube when said tube is in said closed position.

18. The tool of claim 17 wherein:
said tube is hollow and has a vent positioned outwardly of said seal when said tube is in said closed position but movable into said chamber when said tube is in said open position.
